(19) United States
(12) Patent Application Publication
(10) Pub. No.: US 2010/0259820 A1
(43) Pub. Date: Oct. 14, 2010

(54) STEREOSCOPIC IMAGE DISPLAY

(75) Inventors: Katsushige Nakamura, Tokyo (JP); Masao Doi, Tokyo (JP)

Correspondence Address: Edell, Shapiro & Finnan LLC, 1901 Research Blvd, Suite 400, Rockville, MD, 20850, US

(73) Assignee: MITAKA KOHKI CO., LTD, Tokyo (JP)

(21) Appl. No.: 12/599,592

(22) PCT Filed: Apr. 17, 2008
(86) PCT No.: PCT/JP2008/057505

§ 371 Date: May 20, 2010

(30) Foreign Application Priority Data
May 14, 2007 (JP) 2007128402

(51) Int. Cl. G02B 27/22

(52) U.S. Cl. 359/466

(57) ABSTRACT

Optical axes S of eyepiece lenses 15 are parallel to each other and are perpendicular to surfaces of electronic image display panels 12. The optical axes S pass through central parts X of the electronic image display panels 12 that are main observation points of an observer, i.e., an assistant B. When observing the electronic image display panels 12, visual axes of the eyes P of the assistant will not form large angles with respect to the electronic image display panels 12, and therefore, the assistant B can stereoscopically observe electronic images displayed on the electronic image display panels 12 at an original binocular parallax provided by an objective lens 5 of an operating microscope 2. As results, the assistant feels no eye fatigue or headache even when observing the images for a long time.

### TECHNICAL FIELD

The present invention relates to a stereoscopic image display.

### BACKGROUND TECHNOLOGY

There is a known stereoscopic image display that photographs, with a photographing apparatus such as an operating microscope and a digital video camera, left- and right-eye electronic images having binocular parallax to enable a stereoscopic view and displays the pair of left and right electronic images on a pair of left and right electronic image display panels (of liquid crystal, plasma, organic EL, or the like), respectively, so that a viewer views the electronic images through left and right eyepieces, respectively, to observe a stereoscopic image.

An example of a stereoscopic image display is disclosed in Japanese Patent Publication No. 2607828. This related art employs wedge-like prisms for eyepieces to widen the left and right visual axes of an observer to a predetermined angle so that the observer may observe top-bottom-left-right center points of left and right electronic image display panels.

### DISCLOSURE OF INVENTION

Such a related art photographs in advance a pair of electronic images having a predetermined binocular parallax with a photographing apparatus such as an operating microscope and a digital video camera and lets the pair of electronic images to be observed through the eyepieces of the stereoscopic image display that create a further angled state. This involves a drawback to cause a headache for an observer when the observer observes the images for a long time in, for example, brain surgery. When a person looks at an object, the right and left eyes of the person each move toward the inner canthus so that an image of the object may form at the center of the retina. At this time, the visual lines of the right and left eyes form an angle (convergent angle) to produce a difference (binocular parallax) between images viewed by the left and right eyes. The binocular parallax is reconciled by an action of the brain, to stereoscopically sense a depth of the object.

The photographing apparatus such as an operating microscope and a digital video camera forms a convergent angle by refraction of an objective lens and is set to provide an ergonomically optimum convergent angle so that the eyes of an observer may not be fatigued.

According to the related art, the electronic images photographed to have an optimum convergent angle and binocular parallax are observed at a predetermined angle with respect to the stereoscopic image display. If the displayed left and right images involve a slight positional deviation or a rotation, the optimum binocular parallax will lose accuracy. To internally correct the inaccuracy, the brain unnoticeably accumulates fatigue to cause eye fatigue and a headache.

### Means to Solve the Problems

In consideration of such a related art, the present invention provides a stereoscopic image display that allows a long-time observation without fatigue.

According to a first technical aspect of the present invention, the stereoscopic image display includes an electronic image display unit having first and second display surfaces for displaying a pair of left and right electronic images including a binocular parallax, respectively; and a pair of left and right eyepiece optical systems arranged for the electronic images, respectively, optical axes of the eyepiece optical systems passing through the first and second display surfaces, respectively, and being fixed in parallel with each other.

According to a second technical aspect of the present invention, the optical axes are perpendicularly fixed with respect to the first and second display surfaces, respectively.

According to a third technical aspect of the present invention that is additional to the first technical aspect, the pair of left and right electronic images is obtained from a solid-state image sensor through an objective optical system of a stereoscopic microscope.

According to a fourth technical aspect of the present invention that is additional to the first technical aspect, the optical axis of each of the eyepiece optical systems is substantially positioned at the center of the corresponding electronic image.

### BRIEF DESCRIPTION OF DRAWINGS

FIG. 1 is a perspective view illustrating a stereoscopic image display according to an embodiment of the present invention.

FIG. 2 is an explanatory view illustrating an optical system of an operating microscope.

FIG. 3 is a horizontal sectional view illustrating the stereoscopic image display.

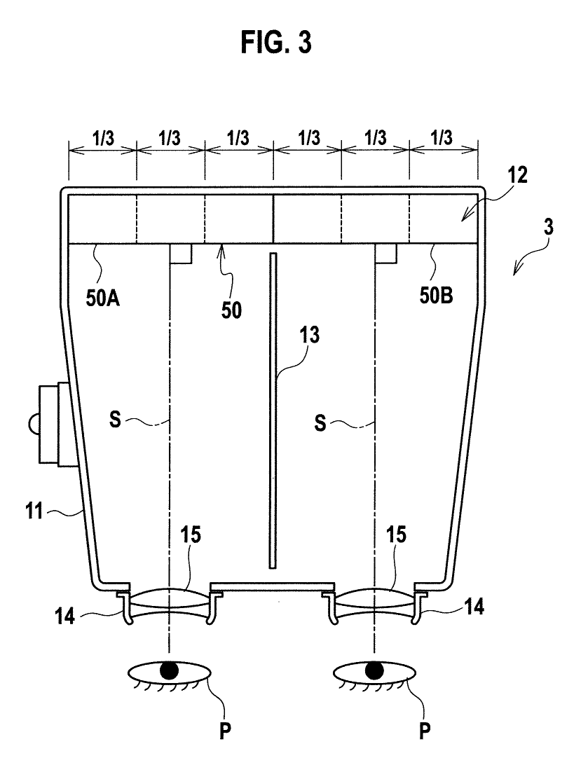

FIG. 4 is a vertical sectional view illustrating the stereoscopic image display. FIG. 5 is a front view illustrating central parts of an electronic image display panel.

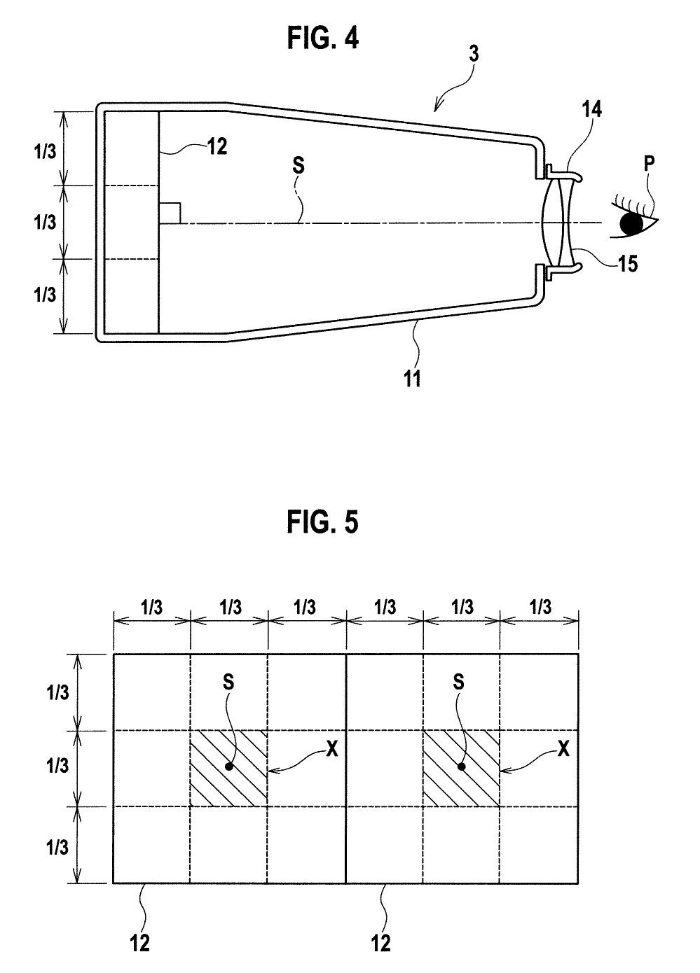

### BEST MODE OF IMPLEMENTING INVENTION

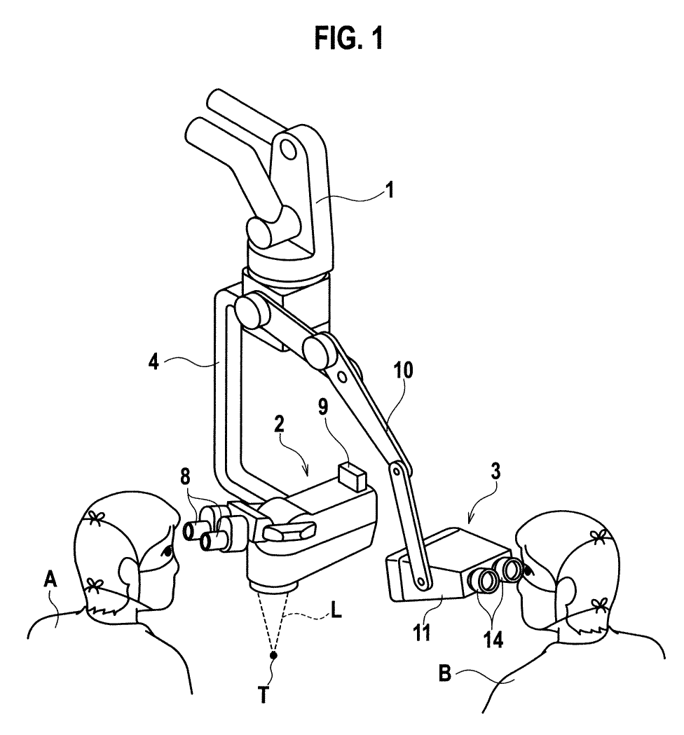

A preferred embodiment of the present invention will be explained with reference to the drawings. FIG. 1 illustrates a front link 1 of a stand apparatus (not illustrated) that supports an operating microscope 2 and a stereoscopic image display 3. The operating microscope 2 is observed by a main operator A and the stereoscopic image display 3 is observed by an assistant B.

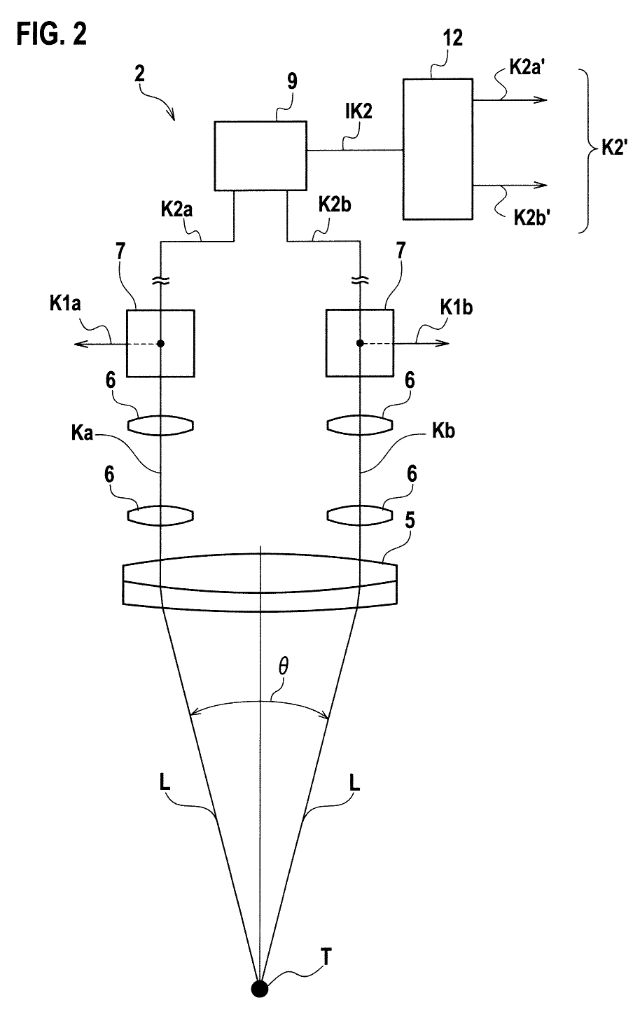

The operating microscope 2 is supported through a suspension arm 4 by the front link 1. The operating microscope 2 contains an objective lens 5, zoom lenses 6, beam splitters 7, and the like. From an operation spot T, a light beam L is guided at a predetermined convergent angle of θ to the objective lens 5, is transmitted through the objective lens 5, and is separated into two systems of optical paths Ka and Kb corresponding to left and right eyes P, respectively. The separated beams passing through the zoom lenses 6 are reflected by the beam splitters 7 toward a rear side (the back side of the plane of FIG. 2) (optical paths K1a and K1b), are bent at optical elements such as prisms (not illustrated) toward a front side (the surface side of the plane of FIG. 2), and are finally guided to a pair of left and right eyepieces 8. Accordingly, the optical paths K1a and K1b extending to the eyepieces 8 are substantially horizontally fixed in a depth direction of the operating microscope 2, and therefore, the eyepieces 8 can be arranged in the vicinity of an optical axis of the objective lens 5, to reduce the height of a main body of the operating microscope 2.

Through the pair of eyepieces 8, the main operator A is able to stereoscopically observe optical images of the operation spot T having a binocular parallax corresponding to the convergent angle of θ.

A top part of the operating microscope 2 is provided with a camera 9 capable of stereoscopic photographing. The camera 9 receives the pair of light beams L (optical paths K2a and K2b) that are separated on the way in the operating microscope 2 and photographs electronic images that are similar to the optical images observed by the main operator A. The camera 9 has a known stereoscopic adaptor (for example, Patent No. 2607828) and uses a single solid-state image sensor to simultaneously photograph right- and left-eye electronic images related to the optical paths K2a and K2b. The solid-state image sensor such as a CCD image sensor has a photographing surface having pixels, i.e., light receiving elements arranged in a lattice pattern, so that light beams for both eyes may form images on the single photographing surface without overlapping each other. Accordingly, a positional relationship such as alignment of the left and right images is correctly maintained in providing and transmitting a stereoscopic image. In addition, the pair of electronic images can be transmitted with one electronic image signal (hereinafter referred to as an imaginary optical path IK2).

On the other hand, the stereoscopic image display 3 is supported through an auxiliary arm 10 by the front link 1. The stereoscopic image display 3 has a case 11 and incorporates a pair of left and right electronic image display panels 12 to display the pair of electronic images related to the operation spot T photographed with the camera 9 of the operating microscope 2.

The electronic image display panels 12 are formed by dividing one oblong liquid crystal display surface having a vertical-to-horizontal ratio of 9:16 into left and right parts (50A and 50B). Namely, the pair of electronic images is fixed, without overlapping each other, relative to the one electronic image display plane 50 (50A and 50B). The electronic image display panels 12 constitute a dot-matrix display that correctly reproduces the positional relationship of the left and right images taken by the solid-state image sensor on the liquid crystal display surfaces.

If the left and right images must be displayed on discrete displays, the displays must correctly be aligned with each other, and if the displays are rearranged, they must be aligned again. It is difficult to achieve such work at a medical scene. It is preferable, therefore, to divide a display surface defined by an imaginary plane into two sections to display left and right images. Namely, displaying electronic images obtained by a single image sensor on a single dot-matrix display surface results in displaying a stereoscopic image that causes no visual fatigue even if no correction is made on the image. In addition, there is no need of aligning the left and right images with each other. Inside the case 11, there is a partition 13 to define spaces corresponding to the pair of electronic image display panels 12. Opposite to the electronic image display panels 12 in the case 11, there is a pair of left and right eyepieces 14. The eyepieces 14 are movable in left and right directions relative to the case 11, to adjust a pupil distance.

The eyepieces 14 have achromatic lenses serving as eyepiece lenses 15 through which the left and right eyes P observe electronic images displayed on the electronic image display panels 12. Optical axes S of the eyepiece lenses 15 are parallel to each other and are perpendicularly fixed with respect to a surface 50 of the electronic image display panels 12. Each optical axis S passes through a central part X of the electronic image display panel 12 that is a main observation part of the observer, i.e., the assistant B. Accordingly, the positional relationship of the left and right images is maintained without deviation in the optical paths (IK2 and K2′) from the stereoscopic camera 9 to the eyepiece lenses 15. As results, the assistant B can observe the electronic images under the same visual conditions as those under which the main operator A observes the optical images through the eyepieces 8. The assistant B, therefore, feels no visual fatigue. Namely, the assistant B observes the stereoscopic electronic image of the operation spot T through the objective lens 5, zoom lenses 6, beam splitters 7, stereoscopic camera 9, and stereoscopic image display 3 (optical paths K2a′ and K2b′), to thereby observe the operation spot T under the same visual conditions as those under which the main operator A observes the optical images of the operation spot T through the objective lens 5, zoom lenses 6, beam splitters 7, and eyepieces 8. In other words, the present invention employs the stereoscopic camera 9 and stereoscopic image display 3, to reproduce a visual environment that is equivalent to arranging eyepieces on the optical paths K2a and K2b.

According to the embodiment, the assistant B mainly observes a central one third range of the electronic image display panel 12 in a top-and-bottom direction and a central one third range of the same in a left-and-right direction. Accordingly, the optical axis S is positioned within a central part X on each electronic image display panel 12 that is the one third range of the panel 12 in the top-and-bottom and left-and-right directions.

Accordingly, when observing the electronic image display panel 12, the visual axis of the eye P of the assistant will not form a large angle with respect to the electronic image display panel 12, and therefore, the assistant B can stereoscopically observe electronic images displayed on the electronic image display panels 12 at an original binocular parallax provided by the objective lens 5 of the operating microscope 2. As results, the assistant feels no eye fatigue or headache even when observing the images for a long time.

According to the above-mentioned embodiment, a single liquid crystal panel is divided into left and right two parts to provide the pair of left and right electronic image display panels 12. It is possible to arrange a pair of discrete electronic image display panels at positions separated from each other in a left-and-right direction and fix them at the positions.

According to the embodiment, an operation spot is observed with the stereoscopic microscope in real time. It is possible, for example, to store stereoscopic electronic images from the stereoscopic microscope in a storage device and reproduce the stored images on the electronic image display 12.

The display panels are not limited to the liquid crystal panels. They may be dot-matrix display panels such as organic EL panels and plasma panels (PDPs).

### Effect of Invention

According to the present invention, the optical axis of each eyepiece lens is perpendicular to the corresponding electronic image display panel and is positioned at a central part of the electronic image display panel. When observing the electronic image display panels, the visual axes of the eyes of an observer form no large angles with respect to the electronic image display panels, and therefore, the observer can stereoscopically observe electronic images displayed on the electronic image display panels at an original binocular parallax. As a result, the observer never feels eye fatigue or headache even when observing the images for a long time.

Also, according to the present invention, a pair of left and right electronic images is photographed with a single image sensor and a pair of left and right electronic image display surfaces is fixed on a single display plane. Due to this, there is no need of adjusting and readjusting an alignment of images at the time of photographing and displaying. An observer can observe electronic stereoscopic images in a visual environment equivalent to that for observing optical images, and therefore, never feels visual fatigue.

The pair of left and right electronic image display panels is formed by dividing one electronic image display panel into left and right parts, and therefore, central parts of the left and right electronic image display panels are close to each other in a left-and-right direction. Accordingly, it is easy to position each of the optical axes of eyepiece lenses within one third range in top-and-bottom and left-and-right directions of the corresponding electronic image display panel.

### (United States Designation)

In connection with United States designation, this international patent application claims the benefit of priority under 35 U.S.C. 119(a) to Japanese Patent Application No. 2007-128402 filed on May 14, 2007 whose disclosed contents are incorporated by reference herein.

1. A stereoscopic image display comprising:
an electronic image display having first and second display surfaces for displaying a pair of left and right electronic images including a binocular parallax, respectively; and
a pair of left and right eyepiece optical systems arranged for the electronic images, respectively, optical axes of the eyepiece optical systems passing through the first and second display surfaces, respectively, and being fixed in parallel with each other.

2. The stereoscopic image display according to claim 1, wherein the first and second display surfaces are fixed relative to a single display plane without overlapping each other.

3. The stereoscopic image display according to claim 1, wherein the optical axes are perpendicularly fixed with respect to the first and second display surfaces, respectively.

4. The stereoscopic image display according to claim 1, wherein the pair of left and right electronic images is taken from a solid-state image sensor through an objective optical system of a stereoscopic microscope.

5. The stereoscopic image display according to claim 4, wherein the pair of left and right electronic images is a pair reproduced from images that have been taken by the solid-state image sensor and have temporarily been stored.

6. The stereoscopic image display according to claim 1, wherein the optical axis of each of the eyepiece optical systems is substantially positioned at the center of the corresponding electronic image.

7. The stereoscopic image display according to claim 6, wherein the optical axis of each of the eyepiece optical systems is positioned within a central one third range of the corresponding electronic image in top-and-bottom and left-and-right directions.

8. The stereoscopic image display according to claim 2, wherein the display plane is a display surface of a dot-matrix display.
